(19) United States
(12) Patent Application Publication
(10) Pub. No.: US 2010/0151182 A1
(43) Pub. Date: Jun. 17, 2010

(54) PROCESS FOR PRINTING AND FINISHING ON FABRICS PARTIALLY OR TOTALLY CONTAINING ARAMIDIC FIBRE IN THE FORM OF FILAMENT AND/OR FLOCK

(76) Inventor: Paolo CANICO, Busto Arsizio (VARESE) (IT)

Correspondence Address: GOTTLIEB RACKMAN & REISMAN PC, 270 MADISON AVENUE, 8TH FLOOR, NEW YORK, NY, 10016-0601, US

(21) Appl. No.: 12/063,622

(22) PCT Filed: Aug. 4, 2006
(86) PCT No.: PCT/EP06/07747

§ 371 Date: Feb. 12, 2008

(30) Foreign Application Priority Data
Aug. 12, 2005 (IT) MI2005A 001577

(51) Int. Cl. D06P 5/20; B32B 33/00; B32B 3/10

(52) U.S. Cl. 428/90; 427/535; 428/196

(57) ABSTRACT

The process for printing and finishing on fabrics partially or totally containing aramidic fibre, in the form of filament and/or flock, consists of carrying out a plasma treatment on the fabric only before the printing process and/or before the finishing process.

The present invention refers to a new process for printing and finishing on fabrics partially or totally containing aramidic fibre, in the form of filament and/or flock.

As known, aramidic fibres are aromatic polyamides with a content of aromatic groups of more than 85%.

Meta-aramidic fibres are those based upon phenylenediamine-isophthalamide, marketed with the trademark Nomex, the chemical structure of which is shown below.

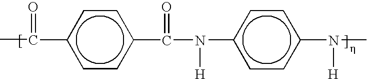

Normex contains meta-phenylene groups, in other words the amidic groups (NH—CO) are attached to the aromatic ring in positions 1 and 3.

This fibre is suitable for applications where high resistance to heat and flames is required. It has an elastic modulus comparable to that of polyester but less variable with temperature.

These fibres are obtained directly from the polymerisation process since they cannot be melted even at temperatures of over 400° C. Indeed, the polymer deteriorates before melting.

There are also aromatic polyamidic fibres with high mechanical characteristics obtained by humid spinning of a liquid-crystalline solution of p-phenylene diamine and terephthalic chloride polymerized in sulphuric acid: Kevlar.

Kevlar is a para-aramidic fibre, since the aramidic groups are attached in positions 1 and 4, as shown in the figure.

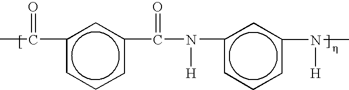

Other fibres classified as meta and para aramidic are known by the trademarks Kernel, Twaron and Conex.

It is also known that so-called “hybrid” fabrics comprise fabrics made with couplings of different types of fibres intended to balance some characteristics or weaknesses of the individual materials.

Frequent examples are those in which aramidic fibres and other fibres of synthetic origin (polyester, polyamide and others) or aramidic fibres and fibres of natural origin (cotton, wool, silk and others) or aramidic fibres and fibres of artificial origin (viscous and others) are woven together.

However, there are many possible types of blends and couplings and they can be made especially for specific conditions of use.

It is also well-known that aramidic fibres display a low surface energy and high chemical inertia, for which reason the adhesion of the printing dyes and of the chemical finishing products, with which they come into contact, is very poor.

Therefore, by applying the printing and finishing processes and techniques currently known to fabrics made with such fibres the end results, in terms of resistance to washing and functional characteristics induced by the finishing, deterioration, appearance and feel, are quite poor.

Normally, the fabrics produced with the aforementioned fibres are nowadays usually printed with pigment-based dyes.

For the above reasons, the fabrics in printed aramidic fibres have low resistance to washing and, moreover, the water-oil repellence values obtained through finishing decrease, often significantly, after the first washes.

The main aesthetic characteristics, such as appearance and feel, after the first washes are greatly altered with respect to the original product, both through the appearance on the surface of parts of fibre not covered by printing or finishing products, and through the substantial loss of printing or finishing products previously applied on the surface.

Moreover, it is very difficult to respect the printing specifications, above all when precise infrared reflectance and/or chromatic tone/intensity values are required.

This drawback becomes of great importance above all in the case of camouflage clothing for military use in which it is vitally important that they have optimal infrared reflectance and chromatic values.

The technical task proposed of the present invention is, therefore, that of making a process for printing and finishing on fabrics partially or totally containing aramidic fibre, in the form of filament and/or flock, which does not have the drawbacks described briefly relative to the prior art.

In this task a purpose of the finding is to make a process for printing and finishing on fabrics partially or totally containing aramidic fibre, in the form of filament and/or flock, which have high resistance to washing and high water-oil repellence values, obtained through finishing, which do not significantly decrease even after numerous washes.

Yet another purpose is to make a process for printing and finishing on fabrics partially or totally containing aramidic fibre, in the form of filament and/or flock, in which the main aesthetic characteristics, such as appearance and feel, after numerous washes, are unchanged with respect to the original product.

A further purpose of the finding is to make a process for printing and finishing on fabrics partially or totally containing aramidic fibre, in the form of filament and/or flock, which does not have the appearance on the surface of parts of fibre not covered by printing or finishing products such as to jeopardise its appearance and that is not subject to the loss of the printing and finishing products previously applied on the surface.

The last but not least purpose is to make a process for printing and finishing on fabrics partially or totally containing aramidic fibre, in the form of filament and/or flock, which respects the specification values, even when precise infrared reflectance and/or chromatic tone/intensity values are required.

This task, as well as these and other purposes are accomplished by a process for printing and finishing on fabrics partially or totally containing aramidic fibre, in the form of filament and/or flock, characterised in that it consists of carrying out a plasma treatment on the fabric before the printing process and/or before the finishing process.

Advantageously, the printing process object of the present invention consists of a plasma pre-treatment, a printing process, a process of fixing vat dyes, acid/premetallised dyes, mixture of vat dyes with acid/premetallised dyes, dispersed dyes, cationic dyes or pigment-based dyes, and washing of the fabrics thus treated, in the presence of particular chemical reactants and precise process conditions.

In order to overcome the high chemical inertia of the fabrics made with the fibres described above, unlike the chemical products and the dyes normally used in the field, and in particular, to activate the surface of such fabrics and increase their energy level, a plasma treatment is carried out that, according to requirements, can be carried out only before the printing step or the finishing step or in both cases.

The last situation has given the best results.

According to the present invention, the plasma treatment can be preceded by a dehumidification process of the fabric, until a residual humidity level of the fabric is reached that is less than 4% of its weight.

The plasma can be obtained through corona treatment, or through atmospheric plasma or preferably through plasma under vacuum.

In this last case, the plasma can be created by using gas, such as air, oxygen, nitrogen, carbon dioxide, argon, helium, ammonium and various mixtures thereof.

Through the use of such gases plasmas are obtained capable of removing organic contaminants of the surface of the fabric, of increasing the roughness value and of modifying the chemical composition of the surface of the fabric, introducing new chemical groups and free radicals.

The effect of such a surface modification becomes apparent with a significant increase in hydrophily of the fibres making up the fabric, allowing the dyes to spread more uniformly and effectively between the meshes of the fabric and to penetrate more stably in the first molecular layers of the surface of the fibres.

Significant surface modifications of the fabrics in aramidic fibres have been discovered for plasma treatment defined by the following operating intervals:

gas=oxygen, nitrogen, argon, helium, carbon dioxide, preferably air;

pressure=50-180 Pa, preferably 80 Pa

current intensity=100-200 A, preferably 180 A, with power supply in the medium frequency field and preferably equal to 10 kHz

speed=5-20 m/min, preferably 10 m/min

During the printing preparation step, the fabric is first pre-treated with plasma, impregnated with a suitable swelling agent whose recipe expressed in g/kg could be the following:

| | |
|---|---|
| Water | 798.5 |
| NP Emulsifier | 1.5 |
| Surfadone LP-100 | 200 |

and dried at low temperature.

The printing step is carried out with either flat screen or rotary cylinder processes, making use of pigment-based dyes, cationic dyes, dispersed dyes, acid/premetallised dyes, vat dyes or their mixtures. In particular, the mixture composed of vat dyes and acid/premetallised dyes has given the best results.

The printing operation foresees the preparation of the recipe of the printing paste containing the dyes.

In the case of the recipe composed of the mixture of vat dyes with acid/premetallised dyes or dispersed dyes or composed only of acid/premetallised dyes, ingredients are foreseen for giving body to the printing paste, fixing agents and agents which assist in improving the characteristics of the printed fabric.

A composition example of the same is reported below, expressed in g/kg:

| | |
|---|---|
| Water | 746.2 |
| Printex GP 10 | 23 |
| Solvitose C 5 | 23 |
| Preventol P 840 | 0.4 |
| Parmetol | 0.4 |
| Helizarin TW Binder | 100 |
| Resin MFP 98 LF | 15 |
| Neopat compound 96/M | 12 |
| Polyethyleneglycol 300 | 50 |
| Oxiton S/P | 30 |

The vat dyes (or Indanthrene) are added to the printing paste, in mixture with either acid/premetallised dyes or with dispersed dyes, or only acid dyes or only cationic dyes for obtaining the desired tone.

After the step of printing and drying, the latter necessary for evaporating the aqueous part, the following steps sequentially follow:
vaporising, preferably in a closed chamber at 173° C., 1050 kg/h of superheated vapour for 42′ (necessary operation for fixing the acid/premetallised or dispersed dyes)
developing (necessary operation for fixing the vat dyes when they are present in the recipe) and stripping the dispersed dyes. These two operations, which can occur simultaneously, are carried out by foulard impregnation (with a squeezing ratio in the range of 50-70% of pick-up) of the printed fabric in full bath with the following recipe, expressed in g/kg:

| | |
|---|---|
| Water | 699.8 |
| Granular Borax | 15 |
| Leophen LG | 4 |
| Caustic Soda 48° Bè | 91.2 |
| Potassium Carbonate | 40 |
| Solvitose C5 | 17 |
| Rongalite 2PH-A | 83 |
| Rongalite 2PH-B | 50 |

and vaporising with tower at 168° C., 2700 kg/h superheated vapour flow rate, 90″ stay time
washing in oxidising environment for the presence of hydrogen peroxide at a temperature of 22° C. for 2′, washing with BIOTEX PS/2 at 98° C. for 3′, neutralisation with acetic acid at 22° C. for 30″, final rinse with water at 22° C. for 30″ and drying with Kenz (ramps) with fabric temperature values of about 80° C.

If the printing was carried out only with acid/premetallised dyes after the step of printing and drying, the latter necessary for evaporating the aqueous part, the following steps sequentially follow:
closed chamber vaporisation as described above
alkaline washing for the presence of caustic soda at 22° C. temperature for 2′, a washing with BIOTEX PS/2 at 98° C. for 3′, the neutralisation with acetic acid at 22° C. for 30″, final rinsing with water at 22° C. for 30″ and the drying with Kenz (ramps) with fabric temperature values of about 80° C.

If the printing was carried out only with cationic dyes, after the step of printing and drying, the latter necessary for evaporating the aqueous part, the follows steps sequentially follow:
vaporisation, preferably in closed chamber; at 133° C., 1050 kg/h of superheated vapour for 42′ (necessary operation for fixing the cationic dyes)
washing and drying of the printed fabric, which preferably occurs with NFS dispersant, in an environment which is acidic due to acetic acid: 1′ at 20° C., 1′ at 30° C., 1′ at 50° C., 1′ at 80° C., 2′ of final rinse at 22° C.; for drying with Kenz (ramps) with fabric temperature values of about 80° C.

The water-oil repellent finishes, normally consisting of fluorocarbonic resins, are carried out through impregnation of the fabric in a bath and subsequent drying and polymerisation of the chemical product applied.

The chemical finishing products, as well as giving the desired functionalities to the fabric, in the case of printed fabrics in aramidic fibre according to the present invention carry out a protective action with regard to the printing dyes.

Also in this case, the action of the plasma is essential to obtain better results and performance with respect to those that can normally be obtained, since, on the one hand, the chemical finishing product remains anchored to the surface of the treated fabric better and for a longer time, and on the other hand, the higher hydrophily of the fabric ensures a better and complete uniformity of the finishing product on the fibres.

### EXAMPLE

A 100% Nomex fabric of weight 150 g/m², consisting of 32 strands/cm (count=45 NM, items=1), in the form of filament, in warp and 23 strands/cm (count=101 NM, items=2), in the form of flock, in weft, was first of all dehumidified, reducing the residual humidity to a value of less than 4% of its weight.

The fabric was then treated with plasma under the following conditions:

gas=air

pressure=80 Pa

current intensity=180 A

speed=10 m/min,

equal to an exposition time=40 sec

The printing of a camouflage design, consisting of the colours maroon, brown, light brown, green and kaki was carried out under the conditions displayed above.

Then the development of the printing was carried out under the conditions displayed above.

Another plasma pre-treatment was carried out before finishing under the following conditions:

gas=oxygen

pressure=80 Pa

current intensity=180 A

speed=10 m/min,

Finishing was carried out using a standard recipe, suitable for giving water-oil repellence characteristics, through the ordinary application process.

The printing results were measured according to the CIELAB method, through which the chromatographic values of the printed and finished fabric according to the method of the present invention are detected, and they are compared with those obtained through the standard printing process, in other words without plasma preparation, but with the same printing and finishing products.

In particular, for the four colours printed, before washing, the following differences have been noted:

Reference: standard dark brown

Sample: Dark brown (new method)

DE=2.971 DL=−0.595DC=−2.911 DH=0.012

Reference: standard light brown

Sample: Light brown (new method)

DE=1.715 DL=−1.261DC=−1.162 DH=0.007

Reference: standard green

Sample: Green (new method)

DE=1.788 DL=−0.771DC=−1.605 DH=0.164

Reference: standard kaki

Sample: Kaki (new method)

DE=1.386 DL=−0.033DC=−1.385 DH=0.035

These values demonstrate that, for all four of the colours printed, there are total colour differences DE, which are more or less pronounced according to whether the colour is light or dark.

In particular, the negative value of DL (difference in lightness) indicates the darker value of the colour obtained on fabrics printed according to the present invention, the negative value of DC (difference in chromaticity) indicates the lower saturation value of the colour obtained on the fabrics printed according to the present invention, the almost unchanged value of DH (difference in hue) indicates that the total difference in colour obtained with the application of the two methods does not depend upon a difference in hue, since there is not one, but mainly upon the colour saturation and upon the lightness, for the darker colours.

Then the end characteristics of the standard product and the product made according to the present invention were measured and compared, the results of which are displayed in the following table:

| OLEOPHOBOL 7752 | g/l | \ | Drying 1′ at 110° C. - |
|---|---|---|---|
| | | | polymerisation 3′ at 160° C. |
| NUVA HP | g/l | 80 | PK recipe 2: 51.5% |
| ACETIC ACID | g/l | 1 | |
| HYDROPHOBOL XAN | g/l | \ | |
| FLEXANOL SOLVENT | g/l | 10 | |

| | |
|---|---|
| | Plasma |
| Standard | treated |
| sample | sample |

PHYSICAL PERFORMANCE

| | | | | |
|---|---|---|---|---|
| OIL REPELLENCY | As such | | 6 | 6 |
| STANDARD AATCC118 | After 5 | not | 4 | 4 |
| | washes at | ironed | | |
| | 60° C. # | | | |
| | After 5 | ironed | 5 | 5 |
| | washes at | | | |
| | 60° C. # | | | |
| SPRAY TEST | As such | | 100 | 100 |
| STANDARD AATCC22 | After 5 | not | 100 | 100 |
| | washes at | ironed | | |
| | 60° C. # | | | |

SOLIDITY OF COLOURS

| | | | | |
|---|---|---|---|---|
| RUBBING | dry | | 3 | 3 |
| STANDARD EN ISO | wet | | 3/4 | 3/4 |
| 105 X12 | | | | |
| DETERIORATION | | Brown | 2 | 4 |
| OF COLOUR | | Light | 3 | 4 |
| AFTER 5 WASHES | | brown | | |
| AT 60° C. # | | Kaki | 4 | 4/5 |
| #EN ISO 6330 2AE | | Green | 4 | 4/5 |

* Air 10′ 80 Pa 180 A
Polymerisation: Arioli 173° C. × 10′ × 1000 kg/h steam - Two steps scheme 1 recipe 2 speed 25
** Oxygen 10′ 80 Pa 180 A

Although there are no differences in terms of physical performance between the two samples, there are significant differences in the results with regard to the deterioration of the colours after washing, which make the sample obtained with the new method in accordance with the values required (¾) in various fields of application in which its use is currently prevented due to the fact that the minimum solidity requirements have not been met.

In practice, it has been noted how the process for printing and finishing on fabrics partially or totally containing aramidic fibre according to the present invention is particularly advantageous to be able to offer increased resistance to washing of the printing dyes and of the chemical finishing products, conserving technical and aesthetic characteristics much more similar to the original product compared to what can be obtained with known techniques.

The printing and finishing process thus conceived can undergo numerous modifications and variations, all of which are covered by the inventive concept; moreover, all of the details can be replaced with technically equivalent elements. In practice, the materials used, as well as the sizes, can be whatever according to the requirements and the state of the art.

1. Process for printing and finishing on fabrics partially or totally containing aramidic fibre, in the form of filament and/or flock, characterised in that it consists of carrying out a plasma treatment on the fabric only before the printing process and/or before the finishing process, before the plasma treatment carrying out a dehumidification process of the fabric out until a residual humidity level of the fabric of less than 4% of its weight is reached, and using vat dyes or a mixture including vat dyes for carrying out the printing.

2. Printing and finishing process according to claim 1, characterised in that the defumidification process of the fabric is carried out until a residual humidity level of the fabric of less than 3% is reached.

3. Printing and finishing process according to claim 1, characterised in that said plasma treatment is carried out through plasma in a vacuum.

4. Printing and finishing process according to claim 1, characterised in that said plasma treatment is carried out through atmospheric plasma.

5. Printing and finishing process according to claim 1, characterised in that said plasma treatment is carried out through corona treatment.

6. Printing and finishing process according to claim 1 characterised in that said vacuum plasma treatment is carried out through a plasma created using gas and preferably air, oxygen, nitrogen, carbon dioxide, argon, helium or ammonia or various mixtures of these gases.

7. Printing and finishing process according to claim 1, characterised in that the operating pressure of said plasma is between 50 and 180 Pa and preferably it is 80 Pa.

8. Printing and finishing process according to claim 1, characterised in that the current intensity of said plasma is between 100 and 200 A and preferably it is 180 A, with power supply in the medium frequency field and preferably equal to 10 kHz.

9. Printing and finishing process according to claim 1, characterised in that the speed of said plasma is between 5 and 20 m/min and preferably it is 10 m/min.

10-15. (canceled)

16. Printing and finishing process according claim 1, characterised in that said finishing process is of the water-oil repellent type, consisting of fluorocarbonic resins and carried out through impregnation of the fabric in a bath and subsequent drying and polymerisation of the chemical product applied.

17. Printing and finishing process according claim 1, characterised in that during the printing preparation step, the fabric is first pre-treated with plasma, then impregnated with a suitable swelling agent, and then dried at low temperature.

18. Printing and finishing process according claim 1, characterised in that ingredients are foreseen for giving body to the printing paste, fixing agents and agents which assist in improving the characteristics of the printed fabric.

19. Printing and finishing process according to claim 18, characterised in that said printing paste comprises: water 746.2 g/kg; Printex GP 10 23 g/kg; Solvitose C 5 23 g/kg; Preventol P 840 0.4 g/kg; Parmetol 0.4 g/kg; Helizarin TW Binder 100 g/kg; Resin MFP 98 LF 15 g/kg; Neopat compound 96/M 12 g/kg; Polyethyleneglycol 300 50 g/kg; and Oxiton S/P 30 g/kg.

20. Printing and finishing process according to claim 1, characterised in that after the step of printing and drying, the latter necessary for evaporating the aqueous part, follows the step of developing, necessary for fixing the vat dyes if they are present in said recipe.

21. (canceled)

22. Fabric partially or totally containing aramidic fibre, in the form of filament and/or flock, characterised in that it has been treated according to the process of claim 1.
